(19) United States
(12) Patent Application Publication
(10) Pub. No.: US 2014/0365819 A1
(43) Pub. Date: Dec. 11, 2014

(54) REBUILDING DATA OF A STORAGE SYSTEM

(71) Applicant: International Business Machines Corporation, Armonk, NY (US)

(72) Inventors: Alastair Cooper, Hursley (GB); Gordon D. Hutchison, Hursley (GB)

(73) Assignee: International Business Machines Corporation, Armonk, NY (US)

(21) Appl. No.: 14/281,744

(22) Filed: May 19, 2014

(30) Foreign Application Priority Data
Jun. 5, 2013 (GB) 1309985.8

(51) Int. Cl. G06F 11/10

(52) U.S. Cl. CPC G06F 11/1092
USPC 714/6.22

(57) ABSTRACT

Proposed are concepts for rebuilding data in a data storage system. Embodiments rebuild data in order of priority as defined by a rebuild policy. Data rebuilding may therefore be undertaken so that important data is rebuilt before less important data for example. For instance, according to one embodiment, a method of rebuilding data in a data storage system includes: determining data to be rebuilt; identifying a plurality of data blocks, each data block comprising data to be rebuilt having a common characteristic; assigning a priority to each of the plurality of data blocks in accordance with a rebuild policy representing a priority to be assigned to a data block based on the common characteristic of its data; and rebuilding the data of each the plurality of data blocks in order of their assigned priority.

### RELATED APPLICATIONS

This application claims priority to United Kingdom Patent Application No. 1309985.8, filed Jun. 5, 2013, which is herein incorporated by reference.

### BACKGROUND

This invention relates to the field of data storage systems and more particularly to rebuilding data of a disk array data storage system.

A Disk array data storage system comprises a plurality of disk drive devices arranged and coordinated to form a single data storage system. Typically, there are three primary design criteria for data storage systems: cost, performance, and availability. “Availability” refers to the ability to access data stored in the storage system and the ability to insure continued operation in the event of a failure. Data availability is normally provided through the use of redundancy, wherein data are stored in multiple locations.

Redundant data is commonly stored using one of two known methods. According to the first or “mirror” method, data is duplicated and stored in two separate areas of the data storage system. For example, in a disk array, identical data is provided on two separate disks in the disk array. This provides the advantages of high performance and high data availability. However, the mirror method is also relatively expensive as it effectively doubles the cost of storing data.

In the second or “parity” method, a portion of the storage area is used to store redundant data, but the size of the redundant storage area is less than the storage space used to store the original data. For example, in a disk array having live disks, four disks might be used to store data with the fifth disk being dedicated to storing redundant data. The parity method is advantageous because it is less costly than the mirror method, but it also has lower performance and availability characteristics in comparison to the mirror method.

The two redundant storage methods detailed above provide for recovery from many common failures within the data storage subsystem itself. These subsystems are widely referred to as Redundant Arrays of Inexpensive/Independent) Disks (RAID) systems.

The simplest array, a RAID 1 system, comprises one or more disks for storing data and a number of additional “mirror” disks for storing copies of the information written to the data disks. The remaining RAID levels, identified as RAID 2, 3, 4 and 5 systems, segment the data into portions for storage across several data disks. One of more additional disks are utilized to store error check or parity information. Additional RAID levels have since been developed.

A device known as the subsystem control is normally utilized to control the transfer of data to and from a computing system to the data storage devices. The subsystem controller and the data storage devices are typically called a data storage subsystem and the computing system is usually called the host (because the computing system initiates requests for data from the storage devices). The subsystem controller directs data traffic from the host to one or more non-volatile data storage devices.

In a computer system employing a disk array, it is desirable that the disk array remains on-line should a physical disk of the disk array fail. If a main physical disk should fail, disk arrays currently have the capability of allowing a spare physical replacement disk to be rebuilt without having to take the entire disk array off-line.

When a disk in a RAID redundancy group fails, the disk array attempts to rebuild data on the surviving disks of the redundancy group (assuming space is available) in such a way that after the rebuild is finished, the redundancy group can once again withstand a disk failure without data loss. The RAID rebuild time may be dependent on factors such as: the size of the disk in the RAID array; and the number of disks in the RAID array. By way of example, it will take a lot longer to replace the data on a 600 GB disk drive than it will on a 72 GB disk drive.

During the RAID rebuild time, the RAID array may be more susceptible to failure or permanent errors. The growing size of individual disk drives results in an increase in the amount of time (and bandwidth) required to rebuild a RAID array when a failure does occur.

### BRIEF SUMMARY

According to one embodiment, a method of rebuilding data in a data storage system includes: determining data to be rebuilt; identifying a plurality of data blocks, each data block comprising data to be rebuilt having a common characteristic; assigning a priority to each of the plurality of data blocks in accordance with a rebuild policy representing a priority to be assigned to a data block based on the common characteristic of its data; and rebuilding the data of each the plurality of data blocks in order of their assigned priority.

According to another embodiment, a computer program product for rebuilding data in a data storage system, includes a computer-readable storage medium having program instructions embodied therewith, the program instructions readable and/or executable by a processor to cause the processor to perform a method including: determining data to be rebuilt; identifying a plurality of data blocks, each data block comprising data to be rebuilt having a common characteristic; assigning a priority to each of the plurality of data blocks in accordance with a rebuild policy representing a priority to be assigned to a data block based on the common characteristic of its data; and rebuilding the data of each the plurality of data blocks in order of their assigned priority.

According to yet another embodiment, a data storage system includes a processor, and logic integrated with and/or executable by the processor, where the logic is configured to: determine data to be rebuilt; identify a plurality of data blocks, each data block comprising data to be rebuilt having a common characteristic; assign a priority to each of the plurality of data blocks in accordance with a rebuild policy representing a priority to be assigned to a data block based on the common characteristic of its data; and rebuild the data of each the plurality of data blocks in order of their assigned priority.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

Preferred embodiments of the present invention will now be described, by way of example only, with reference to the following drawings.

FIG. 1 is a schematic block diagram of a data storage system, according to an embodiment.

FIG. 2 is a flow diagram of a method, according to an embodiment.

FIG. 3 is a schematic block diagram of computer system, according to an embodiment.

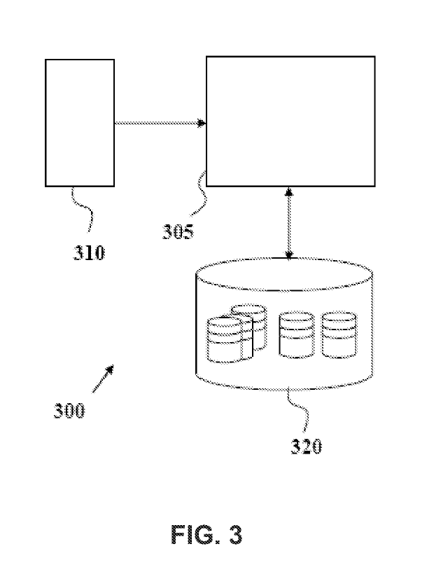

### DETAILED DESCRIPTION

Embodiments disclosed herein provide efficient data rebuilding in a data storage system. Unlike a conventional RAID systems for example, embodiments may rebuild data in order of priority as defined by a rebuild policy. By prioritizing the rebuilding process so that high priority data is rebuilt before low priority data, more important data may be rebuilt more quickly. The rebuild policy may specify the priority of data for the purpose of rebuilding and this rebuild policy may be user-defined, host-defined, or a combination thereof. The priority of data may be defined based on the storage volume, the host, or the application for which it is used.

For instance, according to one general embodiment, a method of rebuilding data in a data storage system includes: determining data to be rebuilt; identifying a plurality of data blocks, each data block comprising data to be rebuilt having a common characteristic; assigning a priority to each of the plurality of data blocks in accordance with a rebuild policy representing a priority to be assigned to a data block based on the common characteristic of its data; and rebuilding the data of each the plurality of data blocks in order of their assigned priority.

The common characteristic of the data to be rebuilt may be derived from a configuration and/or assignment of resources of the data storage system, in various approaches. For example, the characteristic of the data to be rebuilt may be: a storage volume using the data to be rebuilt; a host employing the data to be rebuilt; and/or an application employing the data to be rebuilt. In this way, a higher priority resource (such as a storage volume, host or application) may be rebuilt ahead of a lower priority one.

Rebuilding the data of each of the plurality of data blocks may comprise: sorting the plurality of data blocks into an order of rebuilding based on their assigned priority; and mapping the sorted plurality of data blocks to, e.g., a disk array, of the data storage system in the order of rebuilding, in some approaches.

The data storage system may comprise a disk array having a RAID arrangement, in particular approaches. Embodiments disclosed herein may therefore be employed in conjunction with RAID-based storage systems.

The aforementioned method may further comprise the steps of: receiving an input via a host of the data storage system; and generating the rebuild policy based on the received input, in more approaches. The rebuild policy may therefore be defined by a user and/or host of the data storage system, and this policy may be modified in accordance with changing requirements.

According to another general embodiment, a computer program product for rebuilding data in a data storage system, includes a computer-readable storage medium having program instructions embodied therewith, the program instructions readable and/or executable by a processor to cause the processor to perform a method including: determining data to be rebuilt; identifying a plurality of data blocks, each data block comprising data to be rebuilt having a common characteristic; assigning a priority to each of the plurality of data blocks in accordance with a rebuild policy representing a priority to be assigned to a data block based on the common characteristic of its data; and rebuilding the data of each the plurality of data blocks in order of their assigned priority.

According to yet another general embodiment, a data storage system includes a processor and logic integrated with and/or executable by the processor, the logic being configured to: determine data to be rebuilt; identify a plurality of data blocks, each data block comprising data to be rebuilt having a common characteristic; assign a priority to each of the plurality of data blocks in accordance with a rebuild policy representing a priority to be assigned to a data block based on the common characteristic of its data; and rebuild the data of each the plurality of data blocks in order of their assigned priority.

In various approaches, the logic integrated with and/or executable by the processor may be configured to sort the plurality of data blocks into in order of rebuilding based on their assigned priority, and to map the sorted plurality of data blocks to, e.g., a disk array of, the data storage system in the order of rebuilding.

In some approaches, the data storage system may comprise a disk array having a RAID arrangement, and the processor may comprise a RAID controller. Thus, an embodiment may provide a RAID-based storage system which may be configured/adapted to rebuild data in an order of priority specified in accordance with a rebuild policy. The rebuild policy may be generated based on an input provided to the system, and so may be user-defined and adaptable.

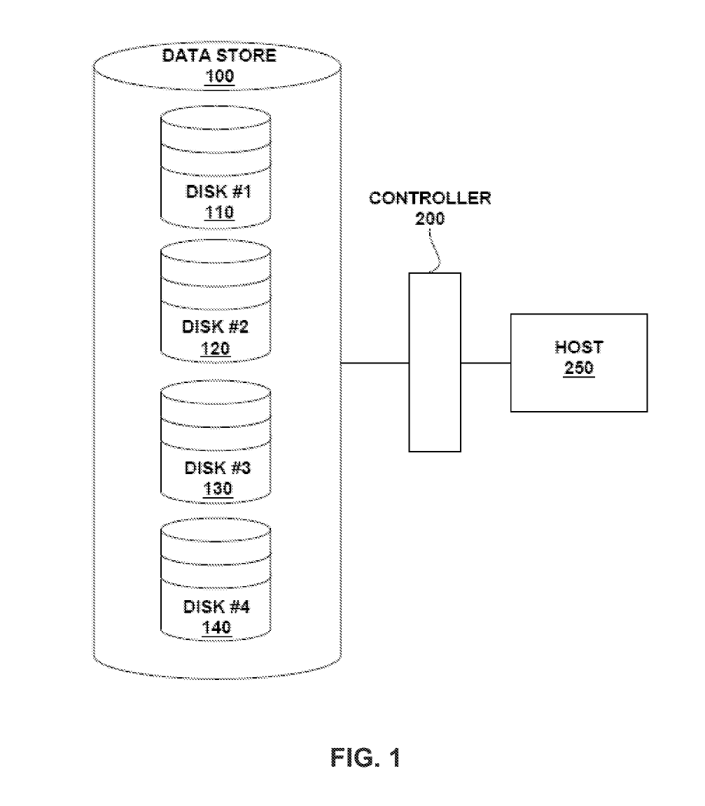

Referring to FIG. 1, there is depicted a data storage system in accordance with an embodiment. Here, a data store 100 comprises a RAID subsystem employing first 110 to third 130 disk hard-disk drives (HDDs) for storing data. The data store 100 is connected to a controller 200 which is configured/adapted to control the transfer of data to and from a host computing system 250 to the HDDs 110,120,130 of the data store 100. In other words, the controller 200 directs data traffic from the host 250 to one or more HDDs of the data store.

The data store 100 may form part of an enterprise storage solution which stores data for servers, applications, websites, or manufacturing systems, for example.

When a HDD of the data store 100 fails, the system attempts to rebuild data on the surviving/remaining HDDs of the redundancy group in such a way that after the rebuild is finished, the data store can once again withstand a disk failure without data loss.

In this embodiment, the controller 200 is configured/adapted to determine data to be rebuilt and identify a plurality of data blocks, each data block comprising data to be rebuilt having a common characteristic. By way of example, the controller 200 may separate the data to be rebuilt based on the storage volumes the data belongs to. In this way, the data to be rebuilt may be categorized according to storage volume.

The controller 200 is configured/adapted to assign a priority to each identified data block in accordance with a rebuild policy which specifies a priority to be assigned to a data block based on its characteristics. The rebuild policy thus represents priority of data for a rebuild process and may be defined by the host 250 and/or a user of the system. A rebuild policy may therefore take account of a determined importance of a particular type of data and represents this in a format that can be used by the controller 250 to determine a relative priority of a data block.

Thus, for the above-mentioned example of categorizing the data to be rebuilt according to storage volume, the controller may determine which storage volume a data block relates to and then assign a priority to the data block based unit storage volume. For example, storage volumes comprising valuable and/or important data may be assigned a higher priority than storage volumes comprising unimportant or superseded data.

After having assigned a priority to each of the identified data blocks, the controller 200 is configured/adapted to sort the data blocks into an order of rebuilding based on their assigned priority, and rebuild the data by mapping the sorted data blocks to the HDDs in the order of rebuilding. In other words, the controller 200 may be configured/adapted to rebuild the data blocks in order of their assigned priority.

Although it has been mentioned above that data to be rebuilt can be categorized and prioritized according to storage volume, it will be understood by a skilled reader that other embodiments may categorize and prioritize data to be rebuilt according to alternative characteristics of the data. For example, data for rebuild may be categorized (e.g. segmented) into data block according to the application(s) it is used by. In such an example, the rebuild policy may define that certain applications are more important than other, and so data blocks used by the more importance applications may be assigned a higher priority than data blocks used by the other applications.

By way of a further example, where multiple hosts employ the data for rebuild, the data for rebuild may be categorized into data blocks according to the host(s) it is used by. In such an example, the rebuild policy may define an order of importance of the hosts, and so a data block may be assigned a priority based on the relative importance of the host that uses the data block.

It will thus be understood that the data storage system of FIG. 1 may rebuild data in an order of priority as represented by rebuild policy. The rebuild policy may be user-defined and provided to the controller 200 from the host 250. Alternatively, the rebuild policy may be stored within the data store and accessed by the controller for use and/or modification.

By prioritizing the rebuilding process so that high priority data is rebuilt before low priority data, high priority data may be rebuilt more quickly than if the data to be rebuilt had equal priority and is rebuilt in no particular order.

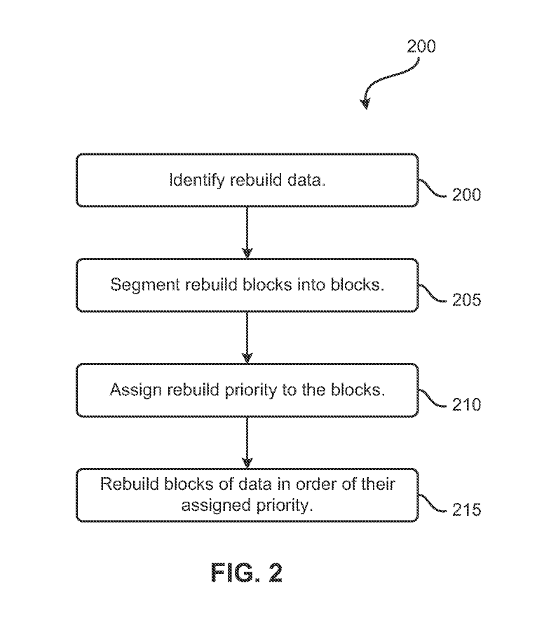

Turning now to FIG. 2, there is depicted a flow diagram of a method of rebuilding data of a disk array in a data storage system according to an embodiment. The method begins in step 200 in which data to be rebuilt is determined. In other words, it is determined what data is required to be rebuilt in order to fix an error that has occurred in the disk array for example. The identified data to be rebuilt will hereinafter be referred to a rebuild data.

Next, in step 205, the rebuild data is analyzed and separated into blocks of data, each block comprising rebuild data having a common characteristic (such as storage volume, host or application, for example). Thus, the rebuild data is categorized into blocks according to a one or more specific characteristics of the data. These blocks of data each comprise rebuild data sharing a property or characteristic in common which can be used to determine a rebuild priority.

In step 210, a priority is assigned to each of the blocks in accordance with a rebuild policy. The rebuild policy represents the relative importance of different types of rebuild data and so is used to determine a priority to be assigned to a data block based on the common property or characteristic of its data.

After having assigned a priority to each of the data blocks in step 210, the data blocks are rebuilt in order of their assigned priority in step 215. Here, the data blocks may be sorted into an order of rebuilding based on their assigned priority and the rebuilt in order (by mapping the sorted data blocks to the disk array in the order of rebuilding for example).

Considering now the above embodiment of FIG. 2 in conjunction with an example where the rebuild policy represents a rebuild ordering preference based on storage volume, it will be appreciated that, in step 205, the rebuild data will be separated into blocks of data each relating a different storage volume. Then, in step 210, each block of data will be assigned a priority based on the storage volume it relates to and its relative importance indicated by the rebuild policy. Finally, in step 215, the blocks of data will be rebuilt in order of assigned priority. Thus, in such an example, storage volumes will be rebuilt in an order of preference as defined by the rebuild policy. The most important storage volume will thus be rebuilt before any other storage volume.

Referring now to FIG. 5, there is illustrated a schematic block diagram of a computer system 300 according to an embodiment. The computer system 300 is configured/adapted to rebuild RAID data in accordance with a rebuild policy that represents a rebuild order preference. The system comprises a processing unit 305 having an input 310 interface, and a RAID data storage system unit 320 connected to the processing unit 305.

The input interface 310 is configured/adapted to receive data from a user representing a rebuild policy (e.g. information indicating a preference for rebuild order).

The RAID data storage system unit 320 is configured/adapted to store data across a plurality of disk drives in a redundant manner.

The processing unit 305 is configured/adapted to execute a computer program which, when executed, causes the system to implement the steps of a method according to an embodiment, for example the steps as shown in FIG. 2.

The processing unit 305 is configured/adapted to receive, via the input internee 310, a rebuild policy. The processing unit 305 identifies data to be rebuilt, for example in order to fix an error that has occurred in the RAID data storage system unit 320. The processing unit 305 then analyses the identified data and separates it into blocks of data, each block comprising data having a predetermined characteristic in common. Thus, the processing unit categorizes the rebuild data into blocks according to a specific characteristics of the data. The blocks of data therefore each comprise data sharing a property or characteristic in common which can be used to determine a rebuild priority.

The processing unit 305 then assign a priority to each of the blocks in accordance with the received rebuild policy. Here, the processing unit 305 refers to the rebuild policy (which represents the relative importance of different types of data) and determines a priority to be assigned to a data block based on the common property/characteristic of its data.

After having assigned a priority to each of the data blocks, the processing unit 305 rebuilds the data of the blocks in order of the assigned priority. Thus, the processing unit 305 rebuilds data of the block assigned the highest priority first, and rebuilds data of the block assigned the lowest priority last.

Embodiments may thus provide an apparatus and method for rebuilding data of RAID system which rebuilds data in an order of preference or priority represented by a rebuild policy.

We now consider a simplified example to demonstrate potential benefits of an embodiment, wherein a data storage system provides three server applications A, B and C. In other words, all three of the server applications A, B and C use a data storage system employing a RAID array according to an embodiment. However, the server applications A, B and C have different levels of importance (due to their differing perceived value or frequency of use for example). Here, by way of example, a rebuild policy associated specifies the server application A to be of the highest importance and server application C to be of the lowest importance. In a situation where one of the disks of the RAID array fails, the system rebuilds data in order of priority specified by the rebuild policy. Thus, in this example, the system will rebuild the data of server application A first, and will rebuild data of server application C last. Accordingly, data for server application A will be completely rebuilt first. This is unlike conventional RAID data rebuilding approaches which does not assign any priority to data of a particular type and so would rebuild data for all three applications in a striped manner, thus resulting in the data for all three applications being completely rebuilt at the same time (just before the end of the rebuild process).

It will be clear to one of ordinary skill in the art that all or part of the method of one embodiment of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to one embodiment of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable medium, for example, e.g. a CD-ROM, DVD, USB stick, memory card, network-area storage device, internet-accessible data repository, and so on, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In one alternative, one embodiment may be realized in the form of a computer implemented method of deploying a service comprising steps of deploying computer program code operable to cause the computer system to perform all the steps of the method when deployed into a computer infrastructure and executed thereon.

In a further alternative, one embodiment may be realized in the form of a data carrier having functional data thereon, the functional data comprising functional computer data structures to, when loaded into a computer system and operated upon thereby, enable the computer system to perform all the steps of the method.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the users computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, the one or more systems described herein according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

While one or more embodiments have been illustrated in detail, one of ordinary skill in the art will appreciate that modifications and adaptations to those embodiments may be made.

It will be further appreciated that embodiments of the present invention may be provided in the form of a service deployed on behalf of a customer to offer service on demand.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot housed to advantage. Any reference signs in the claims should not be construed as limiting the scope.

What is claimed is:

1. A method of rebuilding data in a data storage system, comprising:
determining data to be rebuilt;
identifying a plurality of data blocks, each data block comprising data to be rebuilt having a common characteristic;
assigning a priority to each of the plurality of data blocks in accordance with a rebuild policy representing a priority to be assigned to a data block based on the common characteristic of its data; and
rebuilding the data of each the plurality of data blocks in order of their assigned priority.

2. The method of claim 1, wherein the common characteristic of the data to be rebuilt relates to a configuration of resources of the data storage system.

3. The method of claim 2, wherein the common characteristic of the data to be rebuilt includes at least one of: a storage volume using the data to be rebuilt; a host employing the data to be rebuilt; and an application employing the data to be rebuilt.

4. The method of claim 1, wherein rebuilding the data of each of the plurality of data blocks comprises:
sorting the plurality of data blocks into an order of rebuilding based on their assigned priority; and
mapping the sorted plurality of data blocks to the data storage system in the order of rebuilding.

5. The method of claim 1, wherein the data storage system comprises a disk array having a Redundant Arrays of Inexpensive/Independent Disks, RAID, arrangement.

6. The method of claim 1, further comprising:
receiving an input via a host of the data storage system; and
generating the rebuild policy based on the received input.

7. A computer program product for rebuilding data in a data storage system, the computer program product comprising a computer-readable storage medium having program instructions embodied therewith, the program instructions readable and/or executable by a processor to cause the processor to perform a method comprising:
determining data to be rebuilt;
identifying a plurality of data blocks, each data block comprising data to be rebuilt having a common characteristic;
assigning a priority to each of the plurality of data blocks in accordance with a rebuild policy representing a priority to be assigned to a data block based on the common characteristic of its data; and
rebuilding the data of each the plurality of data blocks in order of their assigned priority.

8. The computer program product of claim 7, wherein the common characteristic of the data to be rebuilt relates to a configuration of resources of the data storage system.

9. The computer program product of claim 7, wherein the common characteristic of the data to be rebuilt includes at least one of: a storage volume using the data to be rebuilt; a host employing the data to be rebuilt; and an application employing the data to be rebuilt.

10. The computer program product of claim 7, wherein rebuilding the data of each of the plurality of data blocks comprises:
sorting the plurality of data blocks into an order of rebuilding based on their assigned priority; and
mapping the sorted plurality of data blocks to the data storage system in the order of rebuilding.

11. The computer program product of claim 7, wherein the data storage system comprises a disk array having a Redundant Arrays of Inexpensive/Independent Disks, RAID, arrangement.

12. The computer program product of claim 7, wherein the method performed by the processor further comprises:
receiving an input via a host of the data storage system; and
generating the rebuild policy based on the received input.

13. A data storage system comprising:
a processor; and
logic integrated with and/or executable by the processor, the logic being configured to:
determine data to be rebuilt;
identify a plurality of data blocks, each data block comprising data to be rebuilt having a common characteristic;
assign a priority to each of the plurality of data blocks in accordance with a rebuild policy representing a priority to be assigned to a data block based on the common characteristic of its data; and
rebuild the data of each the plurality of data blocks in order of their assigned priority.

14. The data storage system of claim 13, wherein the common characteristic of the data to be rebuilt relates to a configuration of resources of the data storage system.

15. The data storage system of claim 14, wherein the common characteristic of the data to be rebuilt includes at least one of: a storage volume using the data to be rebuilt; a host employing the data to be rebuilt; and an application employing the data to be rebuilt.

16. The data storage system of claim 13, wherein the logic integrated with and/or executable by the processor is further configured to:
sort the plurality of data blocks into an order of rebuilding based on their assigned priority; and
map the sorted plurality of data blocks to the data storage system in the order of rebuilding.

17. The data storage system of claim 13, wherein the data storage system comprises a disk array having a RAID arrangement, and wherein the processor comprises a RAID controller.

18. The data storage system of claim 13, wherein the logic integrated with and/or executable by the processor is further configured to:
receive an input via a host of the data storage system; and
generate the rebuild policy based on the received input.
